(19) United States
(12) Patent Application Publication
(10) Pub. No.: US 2017/0269580 A1
(43) Pub. Date: Sep. 21, 2017

(54) Remote Integrated Monitoring Operation System

(71) Applicant: Mitsubishi Electric Corporation, Chiyoda-ku, Tokyo (JP)

(72) Inventors: Masashi HIRAHATAKE, Chiyoda-ku, Tokyo (JP); Natsuko MAEDA, Chiyoda-ku, Tokyo (JP)

(73) Assignee: Mitsubishi Electric Corporation, Chiyoda-ku, Tokyo (JP)

(21) Appl. No.: 15/512,368

(22) PCT Filed: Oct. 22, 2014
(86) PCT No.: PCT/JP2014/078070

§ 371 Date: Mar. 17, 2017

(51) Int. Cl. G05B 23/02; G21C 17/00; G21C 9/00

(52) U.S. Cl. CPC G05B 23/0235; G21C 9/00; G21C 17/00

(57) ABSTRACT

A remote integrated monitoring operation system includes: a unit integrated database for sequentially recording a name of each plant unit, a parameter indicating an event that has occurred in the plant unit, a state of the parameter, and warning classification indicated by the parameter and the state; an inter-unit influence degree evaluation database for recording influence of the event on the other plant unit; a restoration response guidance database for defining a response to the event; a per-unit urgency degree determination section for determining a degree of urgency of each plant unit; an inter-unit influence degree determination section for evaluating a degree of influence of the event on the other plant unit; and a priority determination section for determining priorities between the respective plant units from the degree of urgency and the degree of influence.

### TECHNICAL FIELD

The present invention relates to a remote integrated monitoring operation system.

### BACKGROUND ART

Regarding a nuclear power plant, due to a problem of an attractive location, a plurality of nuclear power units are constructed in the same area, and a central control room is provided for each nuclear power unit from the standpoint of ensuring independency of each nuclear power unit.

In the Fukushima No. 1 nuclear power plant accident, due to the tsunami, which is a common factor influencing the whole area, a plurality of nuclear power units simultaneously came into an abnormal state. However, due to natural disasters other than tsunamis, such as a breakage of a line in a power network in a plant due to lightning, there is a possibility that each nuclear power unit simultaneously falls into an abnormal state.

Even in the case of an abnormality of a single nuclear power unit, due to a change in power load in the plant, there is a possibility that the abnormality influences another nuclear power unit. Also in order to prevent occurrence of a secondary event, an integrated monitoring operation system is needed which evaluates influence of an abnormality of a single nuclear power unit on another nuclear power unit and presents information.

When an accident occurs in a nuclear power plant, the amount of work in accident-time response operations for maintaining the soundness of a nuclear reactor is large, and there is a possibility of falling into a situation where it is difficult to enter the premises of the nuclear power plant, due to problems such as radiation leak. Thus, a remote integrated monitoring operation system is required which enables monitoring and operation at a remote place.

Meanwhile, in a nuclear power plant, most of the operating period thereof is a steady operation, change in the plant state is little, and the utilization rate of a monitoring operation facility is low. Thus, a monitoring operation system is required which can increase the utilization rate of the facility during a steady state to enable monitoring and operation to be performed at efficient power-generation cost.

As an operation management system in which data of a plurality of dispersed plants are collected at one location and these plants are managed collectively, for example, a system disclosed in Patent Document 1 has been proposed.

### CITATION LIST

### Patent Document

Patent Document 1: Japanese Laid-Open Patent Publication No. 4-236127

### SUMMARY OF THE INVENTION

### Problems to be Solved by the Invention

When an abnormality occurs simultaneously in a plurality of nuclear power units in the same area due to a natural disaster such as lightning or an earthquake, if a mistake is made regarding priorities for response, the plurality of nuclear power units fall into a critical state in a linked manner. The operation management system for a power plant group disclosed in Patent Document 1 can centrally manage operation of a plurality of plants, but does not have a function to evaluate priorities of respective nuclear power units and thus has a problem that it is impossible to preferentially handle a situation in which every second counts.

An object of the present invention is to provide a remote integrated monitoring operation system that enables integrated monitoring and operation of all nuclear power units, including preferential monitoring and operation of a nuclear power unit in which an event or an accident has occurred, to be performed in an emergency in accordance with a degree of urgency of the nuclear power unit in which the accident has occurred and a degree of influence of the nuclear power unit on another nuclear power unit.

### Solution to the Problems

A remote integrated monitoring operation system according to the present invention is a remote integrated monitoring operation system for monitoring and operating a plurality of plant units of a plant via a network, the remote integrated monitoring operation system including:

a unit integrated database for sequentially recording, as one record, a name of each plant unit, a parameter indicating an event that has occurred in the plant unit, a state of the parameter, warning classification indicated by the parameter and the state;

an inter-unit influence degree evaluation database for recording, for each combination of the parameter and the state, influence of an event corresponding to the combination on the other plant unit;

a restoration response guidance database including a preferential reference table for recording a response procedure for the event corresponding to the combination of the parameter and the state that have occurred in the plant unit having priority 1 as a priority for restoration response, and a general reference table for recording a response procedure for the event corresponding to the combination of the parameter and the state that have occurred in the plant unit having a priority other than the priority 1;

a per-unit urgency degree determination section for determining a degree of urgency of each of the plant units from the warning classification in the unit integrated database;

an inter-unit influence degree determination section for evaluating influence of the event on the other plant unit from the unit integrated database and the inter-unit influence degree evaluation database; and

a priority determination section for determining priorities between the respective plant units from the degree of urgency determined for each of the plant units by the per-unit urgency degree determination section and the degree of influence determined for each of the plant units by the inter-unit influence degree determination section.

### Effect of the Invention

With the remote integrated monitoring operation system according to the present invention, in an emergency, in accordance with priorities based on a degree of urgency of a nuclear power unit (plant unit) in which an event or an accident has occurred and a degree of influence of the nuclear power unit on the other nuclear power unit, integrated monitoring and operation of all the nuclear power units, including preferential monitoring and operation of the nuclear power unit in which the accident has occurred, are enabled to be performed.

### BRIEF DESCRIPTION OF THE DRAWINGS

FIG. 1 is a block diagram showing the system configuration of a remote integrated monitoring operation system according to Embodiment 1 of the present invention.

FIG. 2 is a block diagram showing the configuration of a plant urgency degree monitoring operation facility according to Embodiment 1 of the present invention.

FIG. 3 is a block diagram showing a relationship of each database used by the plant urgency degree monitoring operation facility according to Embodiment 1 of the present invention.

FIG. 4 is a diagram showing the configuration of a unit integrated database according to Embodiment 1 of the present invention.

FIG. 5 is a diagram showing the configuration of an inter-unit influence degree evaluation database according to Embodiment 1 of the present invention.

FIG. 6 is a diagram showing the configuration of a priority determination database according to Embodiment 1 of the present invention.

FIG. 7 is diagrams showing the configurations of a preferential reference table and a general reference table according to Embodiment 1 of the present invention.

FIG. 8 is a block diagram showing the configuration of a plant integrated monitoring operation facility according to Embodiment 1 of the present invention.

### DESCRIPTION OF EMBODIMENTS

### Embodiment 1

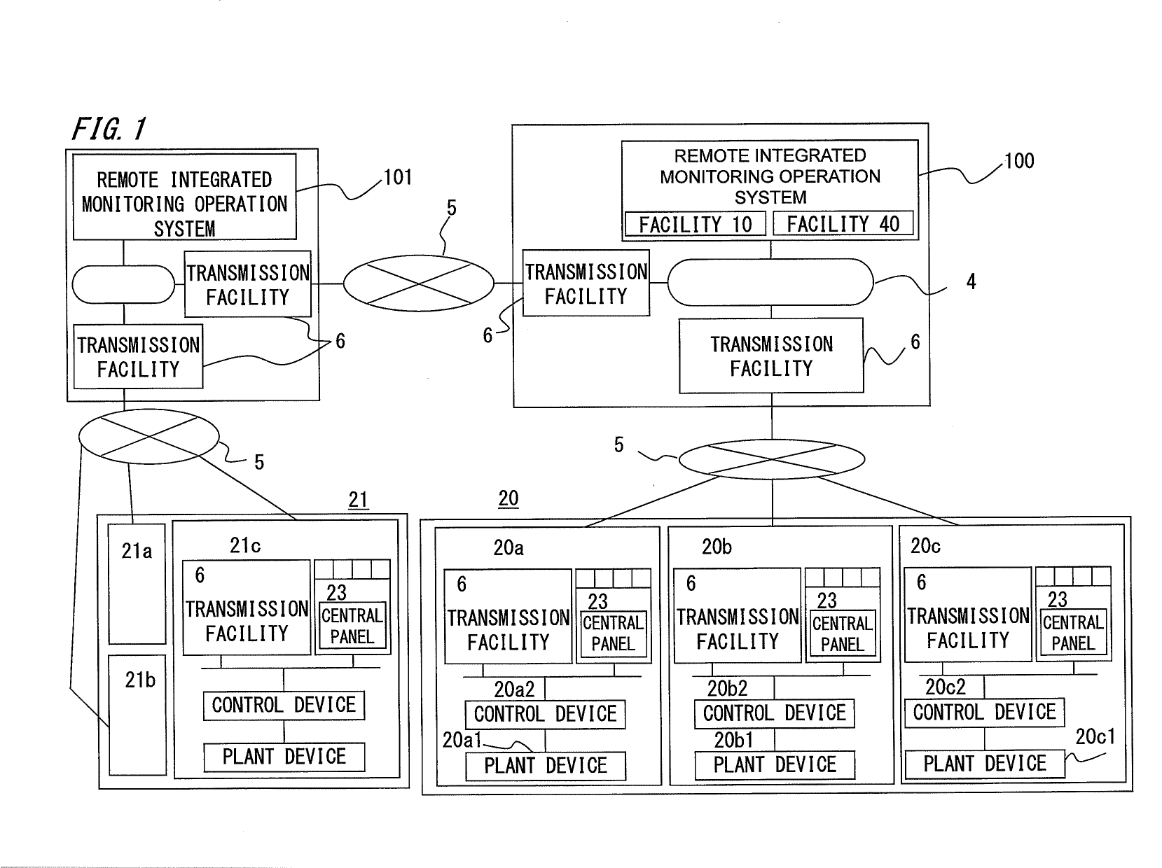

FIG. 1 is a block diagram showing the system configuration of a remote integrated monitoring operation system 100 (hereinafter, referred to merely as system 100) according to Embodiment 1 of the present invention. Hereinafter, an example of use for a nuclear power plant will be described. The system 100 is installed per nuclear power plant 20 that is a monitoring operation target. In FIG. 1, the system 100 is a system that collects plant data of each of nuclear power units 20a to 20c (three nuclear power units are used in the present embodiment) via a remote monitoring operation network 5 (hereinafter, referred to as network 5) thereby to integrally manage individual information on the nuclear power units 20a to 20c to enable plant devices 20a1 to 20c1 of the respective nuclear power units 20a to 20c to be operated. In addition, the system 100 is a system that is installed outside a nuclear power plant that is a monitoring operation target.

Here, each of the nuclear power units 20a to 20c (corresponding to plant units in the claims) refers to one nuclear reactor, such as Unit 1 and Unit 2, and peripheral facilities thereof (including a turbine and a generator), and the nuclear power plant 20 (corresponding to a plant in the claims) refers to a generic name for the plurality of nuclear power units 20a to 20c installed in the same area. In addition, a nuclear power unit 20x used below refers to any one nuclear power unit of the nuclear power units 20a to 20c.

The system 100 includes a plant urgency degree monitoring operation facility 10 (hereinafter, referred to as facility 10), a plant integrated monitoring operation facility 40 (hereinafter, referred to as facility 40), a remote integrated monitoring operation system network 4 (hereinafter, referred to as network 4), and a data transmission facility 6 that connects the system 100 to the network 5.

The nuclear power units 20a to 20c that are monitoring operation targets include data transmission facilities 6 for connecting to the network, the plant devices 20a1 to 20c1 including nuclear reactors as centers, control devices 20a2 to 20c2 for controlling the plant devices, and central control panels 23 for operating the control devices 20a2 to 20c2. When monitoring and operation of the nuclear power unit 20a are performed by the system 100, the central control panel 23 is not used.

The first feature of the system 100 is that when an event or an accident (the accident is a serious event) occurs in a certain nuclear power unit 20x, the system 100 synthetically evaluates the plant data of the respective nuclear power units 20a to 20c by utilizing the integral management of all the nuclear power units 20a to 20c, and presents a restoration response guidance for the whole nuclear power plant 20.

Hereinafter, the configuration and the function of the facility 10 will be described.

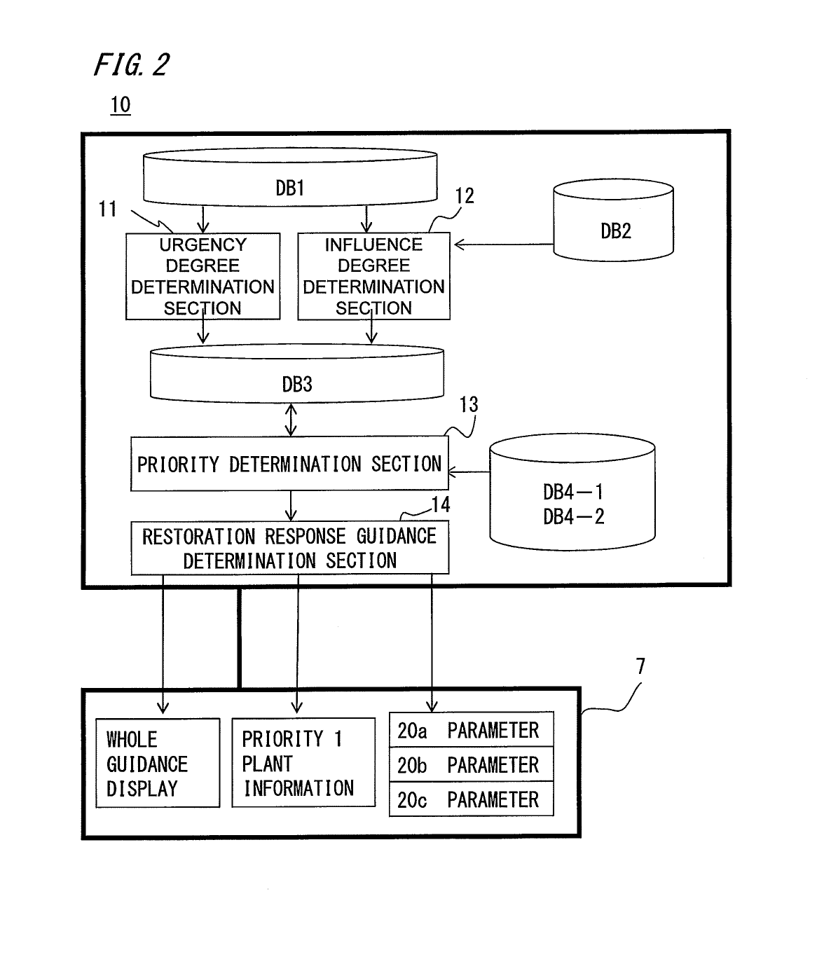

FIG. 2 is a block diagram showing the configuration of the facility 10.

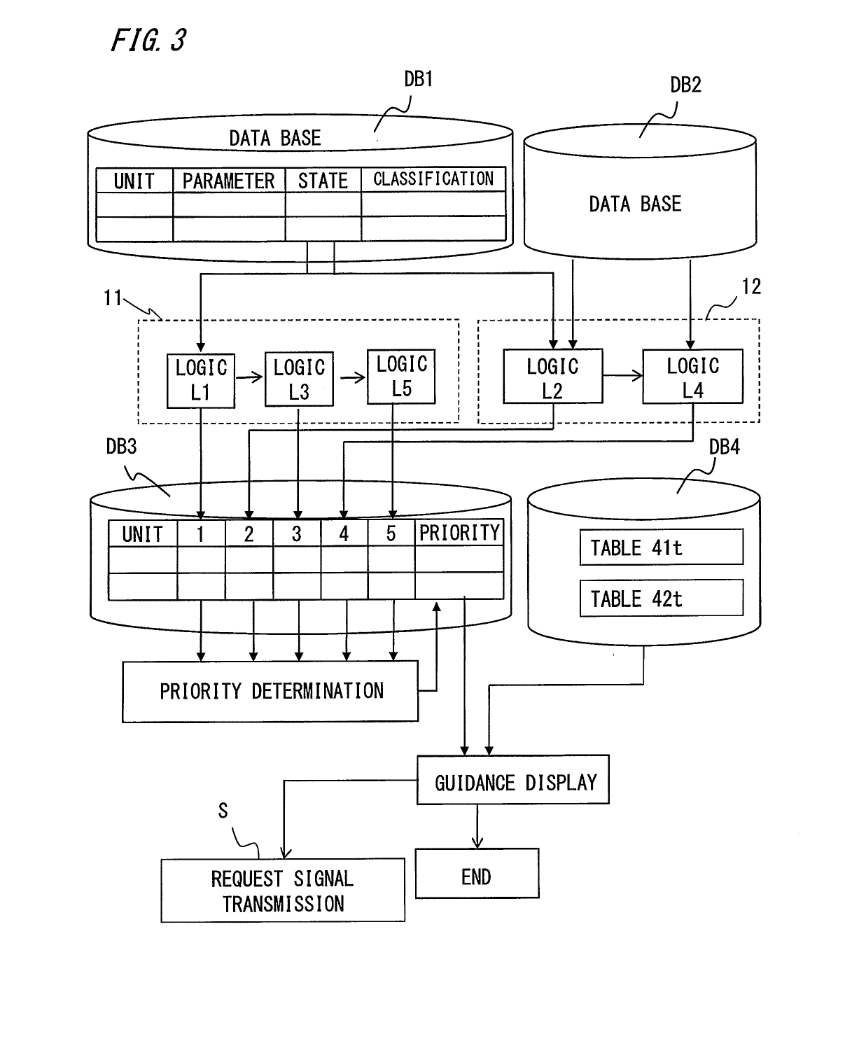

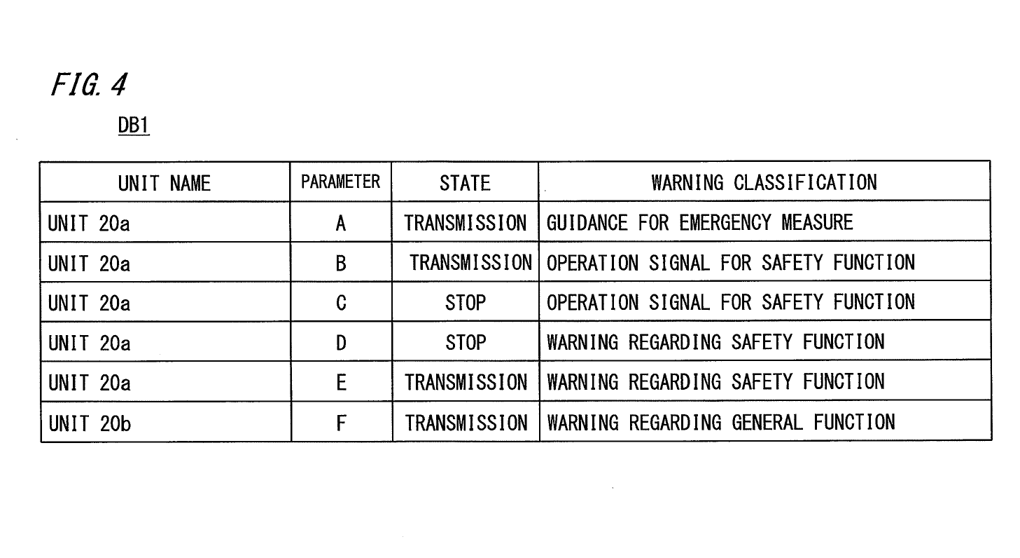

FIG. 3 is a block diagram showing a relationship of each database used by the facility 10. FIG. 4 is a diagram showing a record configuration of a unit integrated database DB1.

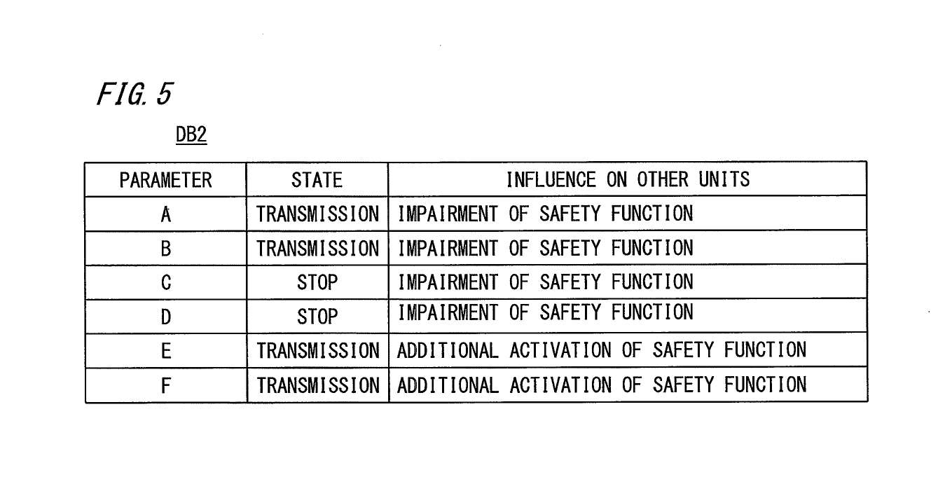

FIG. 5 is a diagram showing a record configuration of an inter-unit influence degree evaluation database DB2.

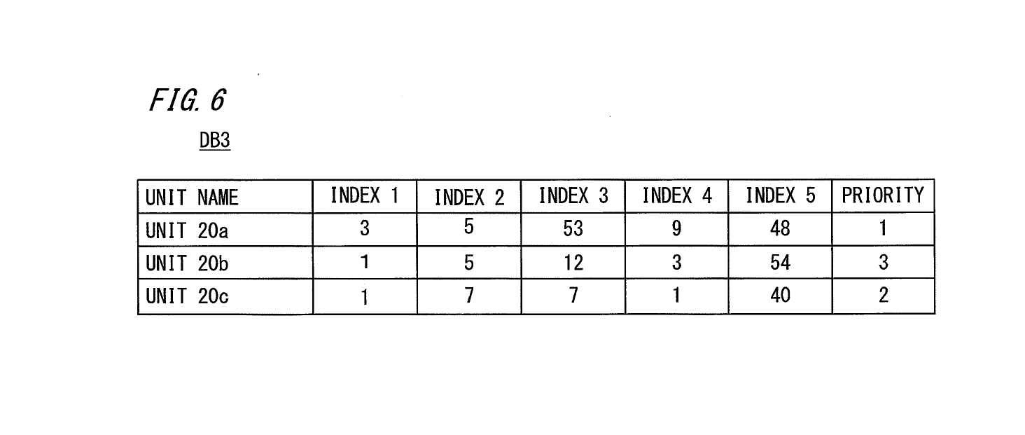

FIG. 6 is a diagram showing a record configuration of a priority determination database.

As shown in FIG. 2, the facility 10 includes a per-unit urgency degree determination section 11, an inter-unit influence degree determination section 12, and a restoration response guidance determination section 14. By later-described determination logic included in each of these sections, for example, the facility 10 evaluates urgency of action against an event or an accident that has occurred in the nuclear power unit 20a within the nuclear power plant 20, and influence of the event or the accident on the other nuclear power units 20b and 20c within the nuclear power plant 20, determines response priorities of the respective nuclear power units 20a to 20c, and instructs restoration response operation procedures for the respective nuclear power units 20a to 20c.

Next, the record configuration of each of the unit integrated database DB1 (hereinafter, referred to merely as DB1. Database is represented merely as DB), the inter-unit influence degree evaluation DB2, and the priority determination DB3 will be described. The DB1 is a database that records a warning transmitted from each of the nuclear power units 20a to 20c, a transmitted operation signal, a stopped operation signal, etc., as one record for every transmission or stop. In item “unit name”, the number of the nuclear power unit 20x in which an event or an accident has occurred is recorded. In item “parameter”, information for identifying a facility, a component, or the like in which the event or the accident has occurred, or the event itself, is recorded. In item “state”, the state of the parameter, such as a warning being transmitted or an operation signal being transmitted or stopped for the event or the accident, is recorded. In item “warning classification”, the type of a warning or the like indicated by a combination of the “parameter” and the “state” is recorded. For example, when a parameter indicating a temperature abnormality of a sea water pump No. 3 of the nuclear power unit 20a is in a transmission state, a record of “warning regarding a safety function” is recorded in the warning classification. When the item “state” shows “transmission”, this means that a state has occurred in which transmission originally should not be performed, and “stop” means a state in which a component that originally should not be stopped has been stopped. Either indicates an unfavorable state.

The inter-unit influence degree evaluation DB2 (hereinafter, referred to merely as DB2) shown in FIG. 5 is a database that is used for, when an event or an accident has occurred in the nuclear power unit 20x, evaluating a possibility that the event or the accident influences the other two nuclear power units. In item “parameter”, information for identifying facilities, components, and the like in which events and accidents that need to be handled may occur in the nuclear power units 20a to 20c are brought together and recorded in advance, and the item “parameter” is associated with the “parameter” in the DB1. Item “state” is an item indicating the state of the parameter, and is also associated with the “state” in the DB1. In item “influence on other units”, influence of an event or an accident corresponding to a combination of the “parameter” and the “state” that have occurred in the nuclear power unit 20, on the other two nuclear power units is recorded.

The priority determination DB3 (hereinafter, referred to merely as DB3) shown in FIG. 6 is a database for totalizing events and accidents that have occurred in the respective nuclear power units 20a to 20c, by index described later, from data recorded in the DB1 and data recorded in the DB2. In item “unit name”, the names of the nuclear power units 20a to 20c included in the nuclear power plant 20 are recorded. One record is present for one nuclear power unit 20x. Items “index 1” to “index 5” and item “priority” will be described later.

Next, urgency degree determination logic L1, L3, and L5 (hereinafter, referred to merely as logic L1, logic L3, and logic L5, and as logic 1, logic 3, and logic 5 in the claims) of the per-unit urgency degree determination section 11 will be described.

The logic L1 provides a function to determine a degree of urgency based on the number of “emergency measure guidances” for each of the nuclear power units 20a to 20c. The logic L1 counts the number of records having “transmission” as the “state” and “emergency measure guidance” as the “warning classification”, for each of the nuclear power units 20a to 20c by using the plant data of the respective nuclear power units 20a to 20c stored in the DB1 (one record in DB1), and totalizes the index 1 for determining the degree of urgency of each of the nuclear power units 20a to 20c. The index 1 is an index having a highest priority.

The logic L3 provides a function to determine a degree of urgency based on the number of warnings regarding the “safety function” for each of the nuclear power units 20a to 20c. The logic L3 counts the number of records in which the “warning classification” relates to the “safety function”, for each of the nuclear power units 20a to 20c by using the plant data of the respective nuclear power units 20a to 20c stored in the DB1, and totalizes the index 3 for determining the degree of urgency of each of the nuclear power units 20a to 20c. The index 3 is an index having a third highest priority.

The logic L5 provides a function to determine a degree of urgency based on the number of warnings regarding a “general function” for each of the nuclear power units 20a to 20c.

The logic L5 counts the number of records in which the “warning classification” relates to the “general function”, for each of the nuclear power units 20a to 20c by using the plant data of the respective nuclear power units 20a to 20c stored in the DB1, and totalizes the index 5 for determining the degree of urgency of each of the nuclear power units 20a to 20c. The index 5 is an index having a fifth highest priority. The totalization results of the indexes 1, 3, and 5 by the logic L1, 3, and 5 are inputted to columns of “index 1”, “index 3”, and “index 5” in records for the respective nuclear power units 20a to 20c in the DB3.

Next, influence degree determination logic L2 and L4 (hereinafter, referred to merely as logic L2 and logic L4 and as logic 2 and logic 4 in the claims) of the inter-unit influence degree determination section 12 will be described. In the facility 10, in parallel to the totalization of the indexes 1, 3, and 5 by the per-unit urgency degree determination section 11, indexes for determining the degree of influence of an event or an accident that has occurred in the nuclear power unit 20x, on the other two nuclear power units is totalized by the logic L2 and L4 of the inter-unit influence degree determination section 12.

The logic L2 provides a function to determine a degree of influence on the other nuclear power units based on “impairment of the safety function” for each of the nuclear power units 20a to 20c. The impairment of the safety function refers to a state in which the safety function is impaired, and the degree of influence on the other nuclear power units is high. Specifically, first, the logic L2 extracts all combinations of the “parameter” and the “state” that have the “impairment of the safety function” as the “influence on other units” in the DB2. Next, the logic L2 counts the number of records in the DB1 in which records the “parameter” and the “state” agree with the “parameter” and the “state” of these combinations, for each of the nuclear power units 20a to 20c, and totalizes the index 2 for determining the degree of influence of an event or an accident that has occurred in any of the nuclear power units 20a to 20c of the nuclear power plant 20, on the other nuclear power units 20a to 20c. The event or accident corresponding to the “impairment of the safety function” has a high degree of influence on the other nuclear power units. Thus, the index 2 is an index having a priority that is the second highest after the index 1.

The logic L4 provides a function to determine a degree of influence on the other nuclear power units based on “additional activation of the safety function” for each of the nuclear power units 20a to 20c. The additional activation of the safety function refers to a state in which a backup safety function has been activated in response to an event or an accident, and is a state in which influence on the other nuclear power units is predicted. Specifically, first, the logic L4 extracts all combinations of the “parameter” and the “state” having the “additional activation of the safety function” as the “influence on other units” in the DB2. Next, the logic L4 counts the number of records in the DB1 in which records the “parameter” and the “state” agree with the “parameter” and the “state” of these combinations, for each of the nuclear power units 20a to 20c, and totalizes the index 4 for determining the degree of influence of an event or an accident that has occurred in any of the nuclear power units 20a to 20c of the nuclear power plant 20, on the other nuclear power units 20a to 20c. The index 4 is an index having a fourth highest priority.

The totalization results of the index 2 and the index 4 by the logic L2 and L4 are inputted into columns of “index 2” and “index 4” in the records for the respective nuclear power units 20a to 20c in the DB3.

A priority determination section 13 of the facility 10 prioritizes nuclear power units 20a to 20c regarding monitoring and operation on the basis of the indexes 1 to 5 calculated by the respective logic L1 to L5, automatically displays the plant data of the nuclear power unit 20a having the highest priority (priority 1) as a process for prompting monitoring and operation of the nuclear power unit 20x having a high priority, displays, in a comparative manner, major parameters of the nuclear power units 20b and 20c having a priority other than the priority 1 as related information, and presents a restoration response operation guidance for the whole nuclear power plant 20 in accordance with a range of influence of an event or an accident that has occurred in the nuclear power unit 20a.

The priority determination is performed by the priority determination section 13. The priority determination section 13 determines priorities of the nuclear power units 20a to 20c, which are monitoring operation targets, in order from the nuclear power unit having a highest value of the index 1. When the values of the index 1 are equal to each other, the priority of the nuclear power unit 20x having a higher value of the index 2 is set to be higher priority. When the values of the index 2 are also equal to each other, the values of the index 3 are compared; when the values of the index 3 are also equal to each other, the values of the index 4 are compared; and when the values of the index 4 are also equal to each other, the values of the index 5 are compared. In this manner, the priorities of the respective nuclear power units 20a to 20c are determined, and the results thereof are inputted to the item “priority” in the DB3. Therefore, in the case of FIG. 6, the nuclear power unit 20a has the priority 1, the nuclear power unit 20c has priority 2, and the nuclear power unit 20b has priority 3.

In accordance with the priorities for monitoring and operation determined by the priority determination section 13, the restoration response guidance determination section 14 displays a restoration response guidance based on the degrees of urgency and the degrees of influence, thereby prompting a response operation on each of the nuclear power units 20a to 20c. That is, the restoration response guidance determination section 14 prompts a response operation corresponding to the “parameter” and the “state” that have occurred for the nuclear power unit 20a having the priority 1, and prompts monitoring and operation in accordance with the priorities also for the other nuclear power units 20b and 20c of which continuous monitoring and operation are required.

Operation of the restoration response guidance determination section 14 will be specifically described.

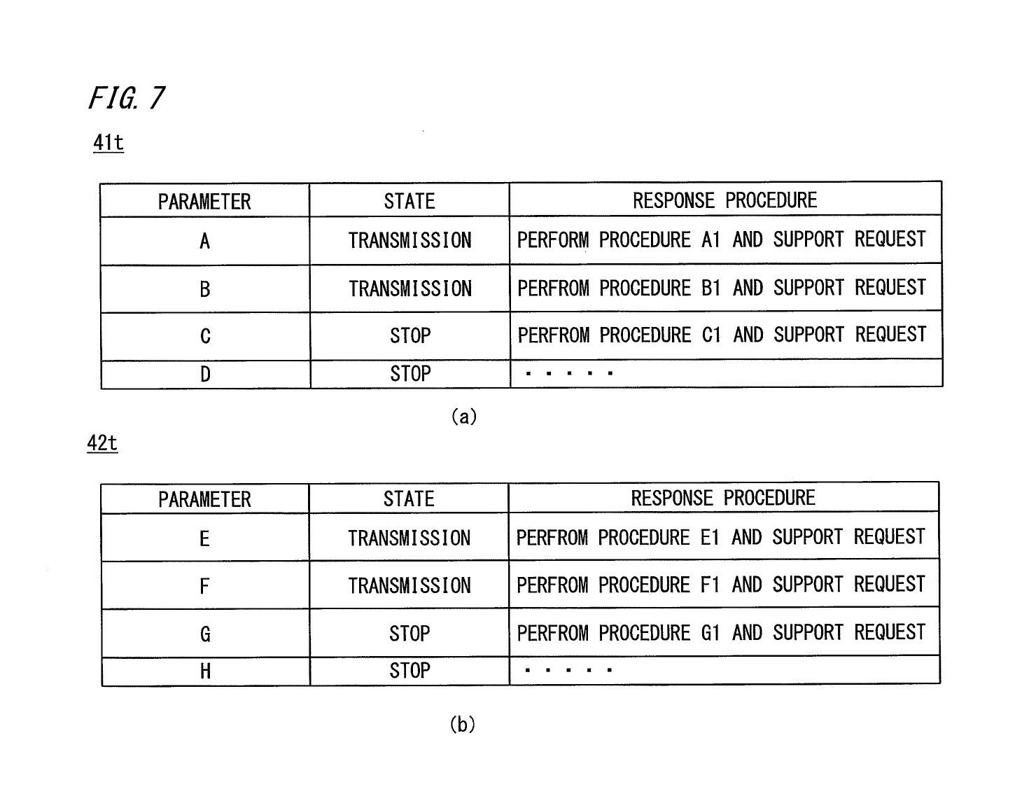

FIG. 7(a) is a diagram showing the configuration of a preferential reference table 41t.

FIG. 7(b) is a diagram showing the configuration of a general reference table 42t.

A restoration response guidance DB4 includes the preferential reference table 41t applied to the nuclear power unit 20x having the priority 1 (here, the nuclear power unit 20a) and the general reference table 42t applied to the other nuclear power units having a other than the priority 1 (here, the nuclear power units 20b and 20c). First, the restoration response guidance determination section 14 extracts records in the DB1 regarding the nuclear power unit 20a having the priority 1 in which records the “parameter” and the “state” agree with the “parameter” and the “state” in the preferential reference table 41t, displays the contents of “response procedure” in the preferential reference table 41t on a monitoring operation terminal. Also regarding the nuclear power units 20b and 20c having a priority other than the priority 1, the restoration response guidance determination section 14 extracts records in the DB1 in which records the “parameter” and the “state” of the nuclear power units 20b and 20c agree with the “parameter” and the “state” in the general reference table 42t, and similarly displays the contents of “response procedure” on the monitoring operation terminal.

As described above, the remote integrated monitoring operation system 100 according to the present invention can integrally monitor the whole nuclear power plant 20 and can automatically switch the monitoring operation target for the monitoring operation terminal to preferentially support monitoring and operation of the nuclear power unit 20a having a high priority.

The second feature of the system 100 is that it is made possible to request another remote integrated monitoring operation system 101 (hereinafter, referred to as system 101) shown in FIG. 1 to join monitoring and operation as an emergency support facility, when the facility 10 determines, in accordance with the contents of the response operation guidance, that it is difficult to handle an event or an accident only with the facilities of the nuclear power plant 20 in which the event or the accident has occurred.

In order for the system 101 for another nuclear power plant 21 to join monitoring and operation of the nuclear power plant 20 in which an accident has occurred, as an emergency support facility, an emergency support request signal S transmitted from the facility 10 to the system 101 in accordance with the contents of the restoration response guidance DB4 for the nuclear power plant 20 in which the accident has occurred, is required.

Transmission of the emergency support request signal S to the other nuclear power plant 21 is defined in the item “response procedure” in the preferential reference table 41t and the general reference table 42t of the restoration response guidance DB4, and the emergency support request signal S is transmitted in accordance with the contents (support request) of the response operation guidance determined by the restoration response guidance determination section 14 on the basis of the degrees of urgency and the degrees of influence.

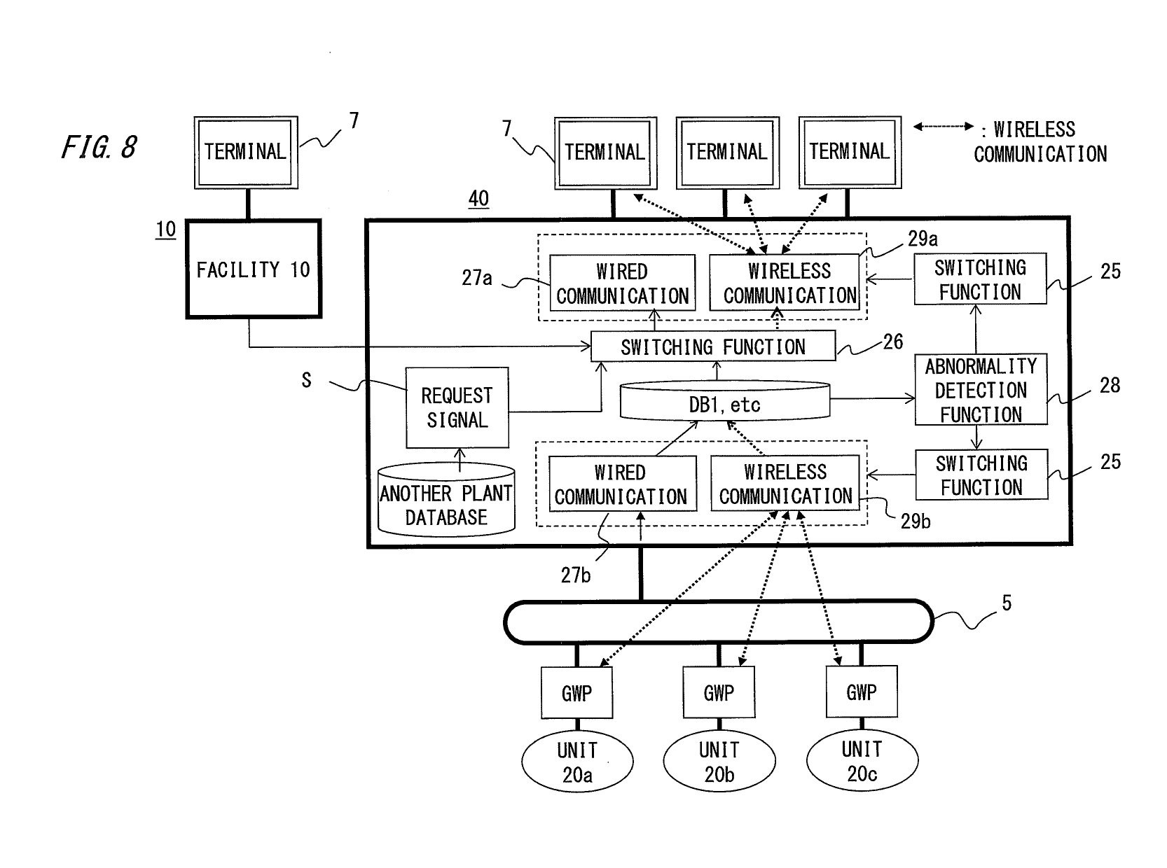

Next, joining of the system 101 will be described with reference to FIGS. 1 and 8.

FIG. 8 is a block diagram showing the configuration of a plant integrated monitoring operation facility that is a facility 40.

The facility 40 of the system 101 that has received the emergency support request signal S from the remote integrated monitoring operation system 100 is specially permitted to join monitoring and operation of the other nuclear power plant 20, monitoring and operation of the nuclear power plant 21 of which monitoring and operation have been performed by the remote integrated monitoring operation system 101 are performed per single unit through a small-scale central control panel 23 installed for each of nuclear power units 21a to 21c, and connection to the nuclear power plant 21 is cut by a monitoring operation target switching function 26. As described above, by disconnecting the nuclear power unit 21a to 21c from the system 101, congestion of monitoring operation information of the nuclear power plant 21 and the nuclear power plant 20 is prevented. In order for the system 101 to function as a remote integrated monitoring operation system for the other nuclear power plant 20, manual connection by the monitoring operation target switching function 26 is further required.

When damage occurs in a wide range due to an earthquake, there is concern about loss of the plant monitoring operation function due to a breakage of a line in the network 4 or the network 5, etc. The facilities 10 and the facilities 40 of the system 100 and the system 101 always check a state of communication via the network 5 by a wired communication abnormality detection function 28. When an abnormality occurs in the wired network 5, a wired communication processing function 27a responsible for communication with each monitoring operation terminal 7 and a wired communication processing function 27b responsible for communication with gateway processors (GWPs) of the respective nuclear power units 20a to 20c are switched to wireless communication processing functions 29a and 29b by a communication processing switching function 25. Accordingly, the monitoring operation function for the respective nuclear power units 20a to 20c can be maintained.

With the remote integrated monitoring operation system 100 according to the present invention, in an emergency, in accordance with priorities based on the degree of urgency of a nuclear power unit 20x (plant unit) in which an event or an accident has occurred and a degree of influence of the nuclear power unit 20x on the other nuclear power units, integrated monitoring and operation of all the nuclear power units 20a to 20c, including preferential monitoring and operation of the nuclear power unit in which the accident has occurred, are enabled to be performed.

When it is determined, in accordance with the contents of the response operation guidance, that it is difficult to handle an accident only with the facilities of the nuclear power plant 20 in which the accident has occurred, transmission of the influence of the accident can be prevented by requesting the other remote integrated monitoring operation system 101 to join monitoring and operation as an emergency support facility.

Since the plant integrated monitoring operation facility 40 includes the wireless communication facility provided for a case of disconnection of the wired network, even when a disaster occurs, it is possible to ensure communication with each nuclear power unit and handle the disaster.

It is needless to say that the system 100 is applicable to a plant other than a nuclear power plant. In addition, the embodiment of the present invention may be modified or abbreviated as appropriate within the scope of the present invention.

1. A remote integrated monitoring operation system for monitoring and operating a plurality of plant units of a plant via a network, the remote integrated monitoring operation system comprising:
a unit integrated database for sequentially recording, as one record, a name of each plant unit, a parameter indicating an event that has occurred in the plant unit, a state of the parameter, warning classification indicated by the parameter and the state;
an inter-unit influence degree evaluation database for recording, for each combination of the parameter and the state, influence of an event corresponding to the combination on the other plant unit;
a restoration response guidance database including a preferential reference table for recording a response procedure for the event corresponding to the combination of the parameter and the state that have occurred in the plant unit having priority 1 as a priority for restoration response, and a general reference table for recording a response procedure for the event corresponding to the combination of the parameter and the state that have occurred in the plant unit having a priority other than the priority 1;
a per-unit urgency degree determination section for determining a degree of urgency of each of the plant units from the warning classification in the unit integrated database;
an inter-unit influence degree determination section for evaluating influence of the event on the other plant unit from the unit integrated database and the inter-unit influence degree evaluation database; and
a priority determination section for determining priorities between the respective plant units from the degree of urgency determined for each of the plant units by the per-unit urgency degree determination section and the degree of influence determined for each of the plant units by the inter-unit influence degree determination section.

2. The remote integrated monitoring operation system according to claim 1, wherein the per-unit urgency degree determination section includes:
logic 1 for counting a number of emergency measure guidances each recorded as one of the warning classification, for each of the plant units from records recorded in the unit integrated database, and determining a degree of urgency of each of the plant units;
logic 3 for counting a number of warnings regarding a safety function that are recorded in the warning classification, for each of the plant units from the records recorded in the unit integrated database, and determining a degree of urgency of each of the plant units; and
logic 5 for counting a number of warnings regarding a general function that are recorded in the warning classification, for each of the plant units from the records recorded in the unit integrated database, and determining a degree of urgency of each of the plant units.

3. The remote integrated monitoring operation system according to claim 2, wherein the inter-unit influence degree determination section includes:
logic 2 for extracting all combinations of the parameter and the state that have impairment of the safety function as an item of influence on other units recorded in the inter-unit influence degree evaluation database, counting a number of records in the unit integrated database in which records the parameter and the state agree with the “parameter” and the “state” of each of the combinations, for each of the plant units, and determining a degree of influence of the event on the other plant unit; and
logic 4 for extracting all combinations of the parameter and the state that have additional activation of the safety function as the item of influence on other units recorded in the inter-unit influence degree evaluation database, counting a number of records in the unit integrated database in which records the parameter and the state agree with the “parameter” and the “state” of each of the combinations, for each of the plant units, and determining a degree of influence of the event on the other plant unit.

4. The remote integrated monitoring operation system according to claim 3, further comprising a priority determination database for recording the numbers of the records corresponding to the logic 1 to the logic 5 as values of index 1 to index 5 for each of the plant units, wherein
the priority determination section compares magnitudes of values of each index for the respective plant units in order from the index 1 to the index 5, sequentially extracts the plant units in order from the plant units having a higher value, and determines priorities.

5. The remote integrated monitoring operation system according to claim 1, wherein the response procedure in the preferential reference table includes a procedure of transmitting an emergency support request signal to another remote integrated monitoring operation system provided for another plant.

6. The remote integrated monitoring operation system according to claim 5, further comprising a communication processing switching function for monitoring the network, and switching to wireless communication when trouble occurs in a wired network.
